(19) United States
(12) Patent Application Publication
(10) Pub. No.: US 2019/0072725 A1
(43) Pub. Date: Mar. 7, 2019

(54) OPTICAL CONNECTOR FERRULE

(71) Applicant: SUMITOMO ELECTRIC INDUSTRIES, LTD., Osaka-shi, Osaka (JP)

(72) Inventors: Takuro WATANABE, Yokohama-shi, Kanagawa (JP); Osamu SHIMAKAWA, Yokohama-shi, Kanagawa (JP); Sho YAKABE, Yokohama-shi, Kanagawa (JP); Takako HOSOKAWA, Yokohama-shi, Kanagawa (JP)

(73) Assignee: SUMITOMO ELECTRIC INDUSTRIES, LTD., Osaka-shi, Osaka (JP)

(21) Appl. No.: 16/085,614

(22) PCT Filed: Mar. 8, 2017
(86) PCT No.: PCT/JP2017/009247

§ 371 Date: Sep. 17, 2018

(30) Foreign Application Priority Data
Mar. 23, 2016 (JP) 2016-058618

(51) Int. Cl. G02B 6/38

(52) U.S. Cl. CPC G02B 6/3834; G02B 6/3863; G02B 6/3853; G02B 6/3882

(57) ABSTRACT

An optical connector ferrule according to an embodiment includes: holding holes into which optical waveguiding members, each of which has a GRIN lens, an optical fiber, and a fusion part that connects the GRIN lens and the optical fiber, are inserted; a ferrule end face at which the holding holes open and which faces a counterpart connector; and stepped parts with which the fusion parts of the optical waveguiding members inserted into the holding holes are aligned.

### TECHNICAL FIELD

An aspect of the present invention relates to an optical connector ferrule.

Priority is claimed on Japanese Patent Application No. 2016-058618, filed on Mar. 23, 2016, the entire content of which is incorporated herein by reference.

### BACKGROUND ART

An expanded beam connector system is disclosed in Patent Literature 1. The expanded beam connector system includes a ferrule, and a holding hole into which a fiber and a GRIN lens fused to the fiber are inserted is formed in the ferrule. The holding hole linearly extends from a ferrule end face, and the GRIN lens is exposed at the ferrule end face in a state in which the GRIN lens and the fiber are inserted into the holding hole. The GRIN lens is polished to have a desired length in a state in which the GRIN lens is exposed at the ferrule end face.

### CITATION LIST

### Patent Literature

[Patent Literature 1] Japanese Unexamined Patent Publication No. 2004-537065

### SUMMARY OF INVENTION

An optical connector ferrule according to an embodiment of the present disclosure includes: holding holes into which optical waveguiding members, each of which has a first optical waveguiding member, a second optical waveguiding member, and a connecting part that connects the first optical waveguiding member and the second optical waveguiding member, are inserted; a ferrule end face at which the holding holes open and which faces a counterpart connector; and first mark parts with which the connecting parts of the optical waveguiding members inserted into the holding holes are aligned.

### BRIEF DESCRIPTION OF DRAWINGS

FIG. 1 is a perspective view illustrating an optical connector ferrule according to a first embodiment.

FIG. 2A is a perspective view of the optical connector ferrule from a direction different from that of FIG. 1.

FIG. 2B is an enlarged perspective view of the vicinity of a ferrule end face of the optical connector ferrule of FIG. 2A.

FIG. 3 is a perspective view illustrating a state in which optical waveguiding members are inserted into the optical connector ferrule.

FIG. 4 is a sectional perspective view illustrating the optical connector ferrule and the optical waveguiding members of FIG. 3.

FIG. 5 is a view illustrating the optical waveguiding member inserted into the optical connector ferrule.

FIG. 6 is a side sectional view illustrating an optical connector having an optical connector ferrule according to a second embodiment.

FIG. 7 is an enlarged side sectional view of the vicinity of a ferrule end face of the optical connector of FIG. 6.

FIG. 8 is a perspective view illustrating an optical connector having an optical connector ferrule according to a third embodiment.

FIG. 9A is a view schematically illustrating a conventional optical coupling structure.

FIG. 9B is a view schematically illustrating the conventional optical coupling structure.

### DESCRIPTION OF EMBODIMENTS

### Problems to be Solved by the Present Disclosure

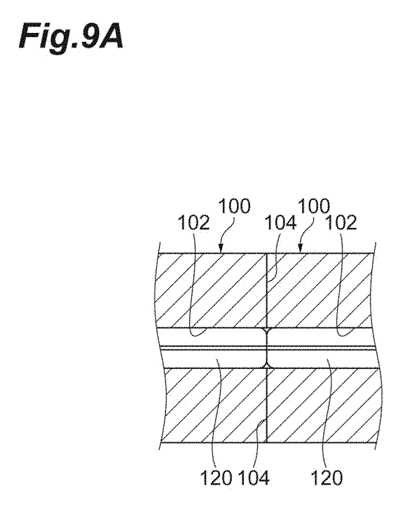

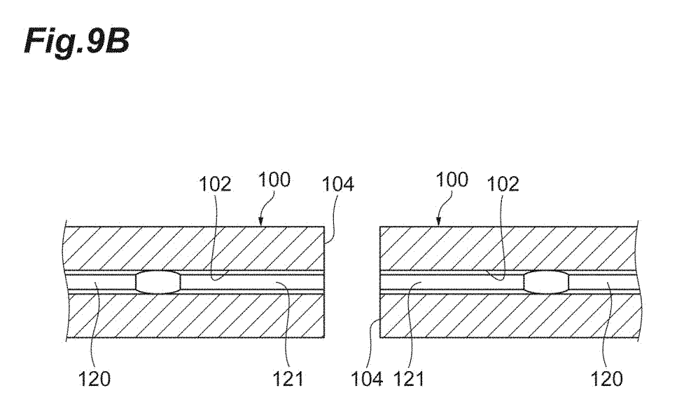

A physical contact (PC) method is generally known as a method for connector connection between optical fibers. FIG. 9A is a side sectional view illustrating an example of a structure of a ferrule in a PC method. A ferrule 100 has a hole 102 for holding an optical fiber 120 on a central axis. The optical fiber 120 is inserted into the hole 102. In this PC method, a tip face of the optical fiber 120 is brought into contact with and pressed against a tip face of an optical fiber of a counterpart connector, and thereby the optical fibers 120 are optically coupled.

However, the PC method has the following problems. When the connection is performed in a state in which foreign materials adhere to a ferrule end face 104, the foreign materials adhere closely to the ferrule end face 104 due to a pressing force. There is a need to frequently perform cleaning in order to prevent close adhesion of foreign materials. In the case of a multi-fiber ferrule for simultaneously connecting a plurality of optical fibers 120, a predetermined pressing force is required for each optical fiber 120. Thus, as the number of optical fibers 120 increases, a greater force is required for the connection. With respect to each of the aforementioned problems, as illustrated, for instance, in FIG. 9B, a structure in which GRIN lenses 121 are fused and connected to tip sides of the two optical fibers 120 connected to each other and an interval is provided between these GRIN lenses 121 may be conceived.

However, in the structure in which the optical waveguiding members such as the GRIN lenses 121 are connected to the tip sides of the optical fibers, an optically coupled state is changed depending on a length of the optical waveguiding member in a direction of a central axis of the hole, and thus the length of the optical waveguiding member needs to be adjusted with high accuracy. In addition, it is desired to enable the length of the optical waveguiding member to be easily adjusted.

The present disclosure is directed to providing an optical connector ferrule capable of adjusting a length of an optical waveguiding member with ease and with high accuracy.

### Advantageous Effects of the Invention

According to the present disclosure, the length of the optical waveguiding member can be adjusted with ease and with high accuracy.

### Description of Embodiments

First, details of embodiments of the present disclosure will be listed and described. An optical connector ferrule according to an embodiment of the present disclosure includes: holding holes into which optical waveguiding members, each of which includes a first optical waveguiding member, a second optical waveguiding member, and a connecting part that connects the first optical waveguiding member and the second optical waveguiding member, are inserted; a ferrule end face at which the holding holes open and which faces a counterpart connector; and first mark parts with which the connecting parts of the optical waveguiding members inserted into the holding holes are aligned.

According to the aforementioned optical connector ferrule, positions of the connecting parts are matched with the first mark parts, and thereby the positions of the connecting parts can be fixed with ease and with high accuracy. In this way, the positions of the connecting parts can be fixed inside the optical connector ferrule, and thus lengths of the optical waveguiding members inserted into the optical connector ferrule can be adjusted with ease and with high accuracy.

Further, each of the holding holes may include a small diameter part that extends from the ferrule end face, and a large diameter part that extends from an end opposite to the ferrule end face, and the first mark parts may be stepped parts, each of which is provided between the small diameter part and the large diameter part. In this case, the positions of the connecting parts are matched with positions of the stepped parts, and thereby alignment of the connecting parts can be performed with ease and with high accuracy.

Further, the first optical waveguiding member may be a GRIN lens, the second optical waveguiding member may be an optical fiber, and the connecting part may be a fusion part that fuses the GRIN lens and the optical fiber; the GRIN lens may be inserted into the small diameter part and exposed at the ferrule end face; a diameter of the fusion part may be larger than a diameter of the GRIN lens; a diameter of the small diameter part may be smaller than the diameter of the fusion part, and may be larger than the diameter of the GRIN lens; and a diameter of the large diameter part may be larger than the diameter of the fusion part. In this case, the GRIN lenses are inserted into the small diameter parts, so that the fusion parts can be aligned with the stepped parts. In this state, lengths of the GRIN lenses can be adjusted. Since the diameters of the fusion parts are larger than the diameters of the small diameter parts and are smaller than the diameters of the large diameter parts, when the GRIN lenses are inserted into the small diameter parts, the fusion parts automatically abut the stepped parts. Therefore, by inserting the GRIN lenses into the small diameter parts, alignment of the fusion parts with the stepped parts can be more easily performed.

Further, the optical connector ferrule may further include a hole configured to allow the stepped parts to be visible from the outside of the optical connector ferrule. In this case, since the stepped parts are visible through the hole, the alignment of the connecting parts with the stepped parts can be easily performed.

Further, the optical connector ferrule may further include a transparent part configured to allow the stepped parts to be visible from the outside of the optical connector ferrule. In this case, since the stepped parts are visible through the transparent part, the alignment of the connecting parts with the stepped parts can be easily performed.

Further, the optical connector ferrule may further include second mark parts configured to allow a polishing amount of the ferrule end face to be visible from the outside of the optical connector ferrule. Since the polishing amount of the ferrule end face is visible from the second mark parts, lengths of the optical waveguiding members that extend from the stepped parts to the ferrule end face are visible. Therefore, when the optical waveguiding members exposed at the ferrule end face are polished, the lengths of the optical waveguiding members can be easily adjusted.

### Details of Embodiments

Hereinafter, specific examples of the optical connector ferrule according to the embodiment of the present disclosure will be described with reference to the drawings. The present invention is not limited to these examples, and the scope of the present invention is defined by the claims, and is intended to include all modifications and alternations within the meanings and scopes equivalent to the claims. In the following description, in the description of the drawings, the same reference signs are given to identical or equivalent elements, and duplicate description thereof will be omitted.

### First Embodiment

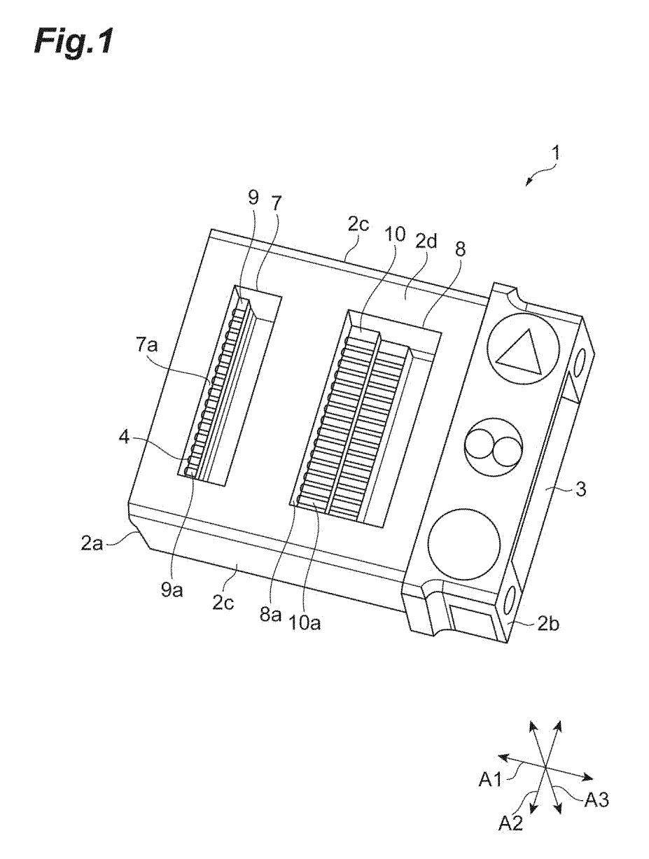

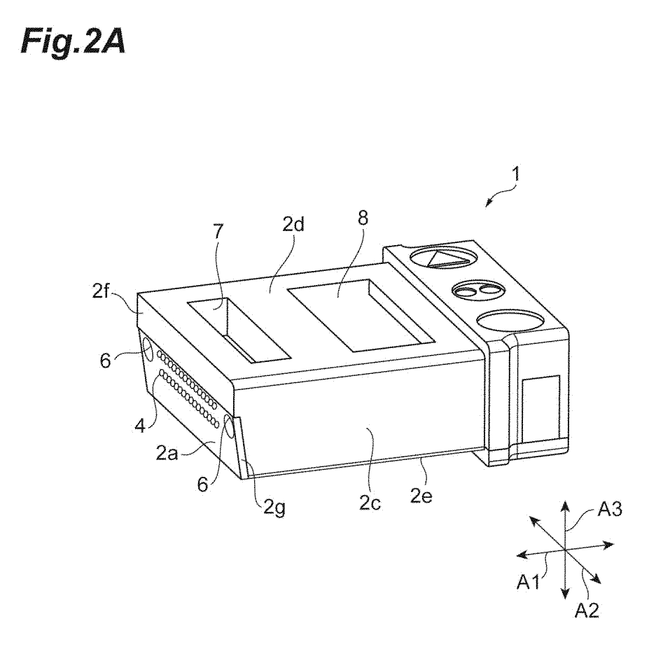

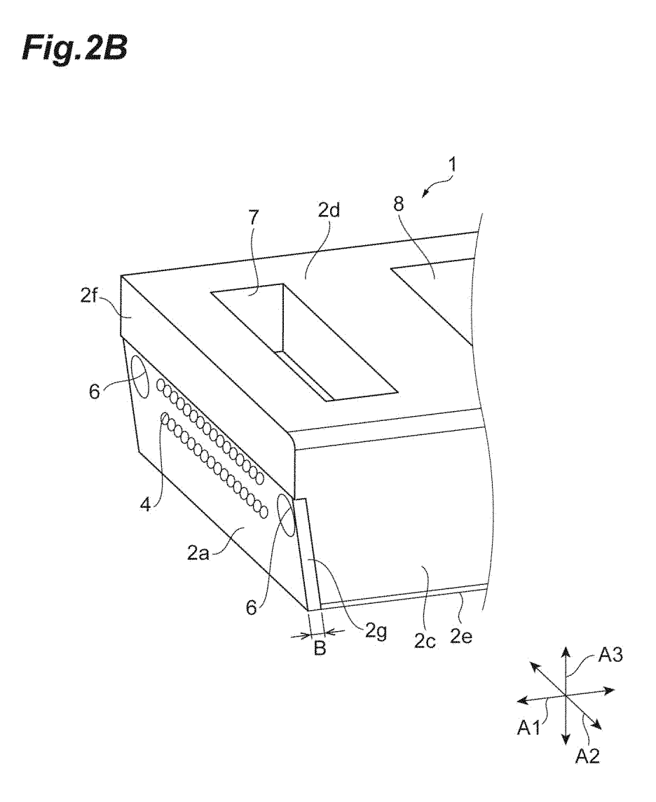

FIG. 1 is a perspective view illustrating an optical connector ferrule according to a first embodiment. FIG. 2A is a perspective view of the optical connector ferrule from a direction different from that of FIG. 1. FIG. 2B is an enlarged perspective view of the vicinity of a ferrule end face of the optical connector ferrule of FIG. 2A. The optical connector ferrule 1 of the present embodiment has a rectangular parallelepiped shape in external appearance, and is formed of, for instance, a resin.

The optical connector ferrule I is connected to a counterpart connector in a connecting direction A1. As illustrated in FIGS. 1, 2A and 2B, the optical connector ferrule 1 has a flat ferrule end face 2a that is provided on one end in the connecting direction A1 and faces the counterpart connector, a rear end face 2b that is provided on the other end in the connecting direction A1, a pair of lateral surfaces 2c that extend in the connecting direction A1, a top surface 2d, a bottom surface 2e, and a front surface 2f that is located above the ferrule end face 2a.

An introduction hole 3 for receiving a plurality of optical waveguiding members is formed in the rear end face 2b.

The optical connector ferrule 1 further includes a plurality of holding holes 4 that hold the optical waveguiding members. Each holding hole 4 is formed in the shape of, for instance, a cylindrical hole. The plurality of holding holes 4 extend from the introduction hole 3 to the ferrule end face 2a, and a front end of each holding hole 4 opens at the ferrule end face 2a. Each holding hole 4 extends along a central axis that extends in the connecting direction A1, and a direction of the central axis of each holding hole 4 is identical to the connecting direction A1. Openings of the plurality of holding holes 4 are arranged on the ferrule end face 2a in a direction A2 intersecting the connecting direction A1 in a row, and the plurality of holding holes 4 arranged in a row are provided on two upper and lower tiers. The direction A2 is a direction that is orthogonal to, for instance, the connecting direction A1, and is a direction that is parallel to the ferrule end face 2a and the top surface 2d.

The ferrule end face 2a is inclined with respect to a direction that is orthogonal to planes extending in the connecting direction A1 and the direction A2. That is, a normal direction of the ferrule end face 2a is inclined with respect to the directions of the central axes of the holding holes 4. Thereby, reflected return light on the ferrule end face 2a can be reduced. The front surface 2f is located closer to the top surface 2d than the ferrule end face 2a in which the holding holes 4 are provided. The front surface 2f extends in parallel to a direction A3 that intersects the direction A2. The direction A3 is a direction that is orthogonal to a plane extending, for instance, in the connecting direction A1 and the direction A2.

Recesses 2g linearly extending along the ferrule end face 2a are formed in ends (front ends) of the lateral surfaces 2c of the optical connector ferrule 1 which are close to the ferrule end face 2a. Each recess 2g has a fixed width B in the connecting direction A1. The ferrule end face 2a is polished before the optical connector ferrule 1 is used, and each recess 2g is a mark part (a second mark part) that indicates a polishing amount of the ferrule end face 2a. That is, the ferrule end face 2a is polished in the optical connector ferrule 1 until the recesses 2g are gone.

The optical connector ferrule 1 further includes a pair of guide holes 6. A guide pin for fixing a relative position between the optical connector ferrule 1 and an optical connector ferrule of the counterpart connector is inserted into each guide hole 6. The pair of guide holes 6 extend using the connecting direction A1 as the central axis, and are arranged in the direction A2. The guide holes 6 open at the ferrule end face 2a, and these openings are provided at positions between which the plurality of holding holes 4 are sandwiched (in other words, on opposite ends of the holding holes 4 in the direction A2).

Further, the optical connector ferrule 1 has first and second holes 7 and 8 that make the inside of the optical connector ferrule 1 visible, and the first and second holes 7 and 8 are formed in the top surface 2d together. The first and second holes 7 and 8 are formed in a rectangular shape that is recessed from the top surface 2d and extends in the direction A2. A length of the first hole 7 in the direction A2 is the same as, for instance, a length of the second hole 8 in the direction A2, and a width of the first hole 7 in the connecting direction A1 is narrower than a width of the second hole 8 in the connecting direction A1. In addition, the first hole 7 is provided closer to the ferrule end face 2a than the second hole 8.

The first hole 7 has a front wall 7a in which the holding holes 4 are formed, and the plurality of holding holes 4 extend from the front wall 7a toward the ferrule end face 2a in the connecting direction A1. Stepped parts 9 extending in the direction A2 are provided inside the first hole 7. The stepped parts 9 are mark parts (first mark parts) that adjust a relative position of the optical waveguiding member relative to the optical connector ferrule 1. A length from each stepped part 9 to the ferrule end face 2a can be seen by looking at the width B of each recess 2g of the optical connector ferrule 1.

Each stepped part 9 has a fixed width in the connecting direction A1, and the width of each stepped part 9 is, for instance, 10 μm. The stepped parts 9 are parts on which a plurality of optical waveguiding members are loaded, and have a plurality of hemispheric recesses 9a in which the optical waveguiding members are loaded. The plurality of recesses 9a are arranged in the direction A2, and each holding hole 4 extends from one of the recesses 9a toward the ferrule end face 2a.

The second hole 8 is a hole for introducing an adhesive into the inside of the optical connector ferrule 1. The second hole 8 has a front wall 8a, and the plurality of holding holes 4 extend from the front wall 8a toward the first hole 7 in the connecting direction A1 . Stepped parts 10 similar to the stepped parts 9 are provided inside the second hole 8, and a width of each stepped part 10 in the connecting direction A1 is longer than, for instance, the width of each stepped part 9 in the connecting direction A1. The stepped parts 10 have a plurality of hemispheric recesses 10a in which the optical waveguiding members are loaded. The adhesive is introduced into the second hole 8 in a state in which the optical waveguiding members are disposed in these recesses 10a, and the adhesive is filled in the optical connector ferrule 1. The adhesive filled in the optical connector ferrule 1 is cured, and thereby the optical waveguiding members are fixed.

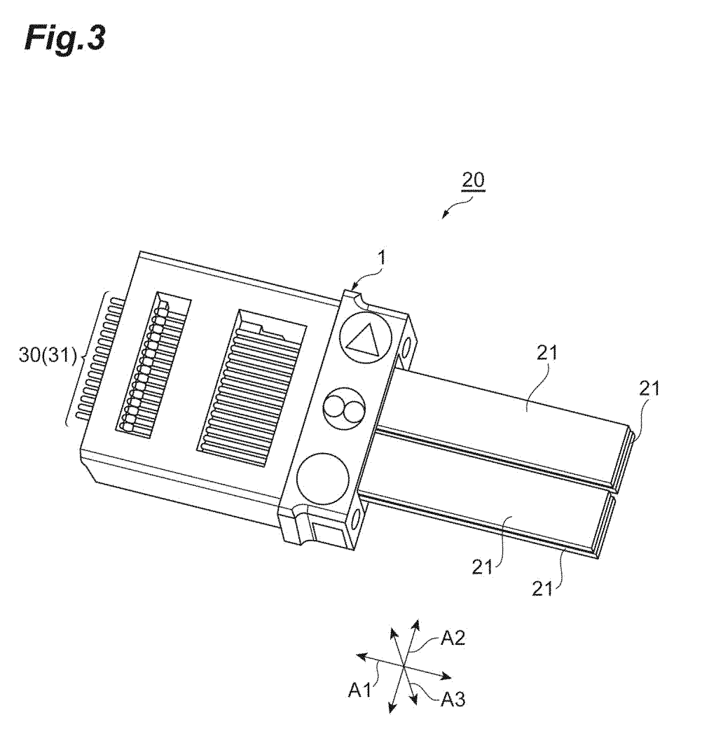

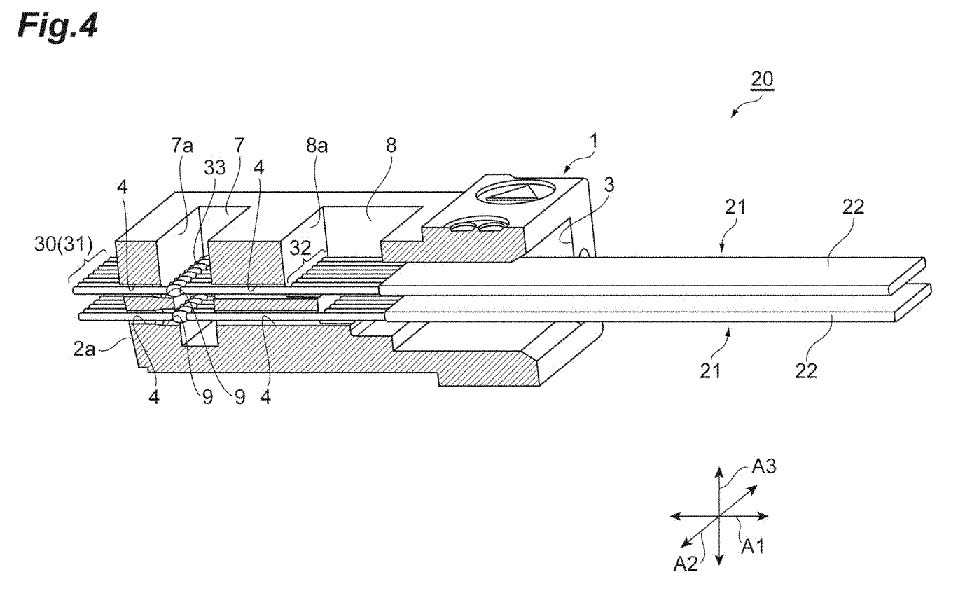

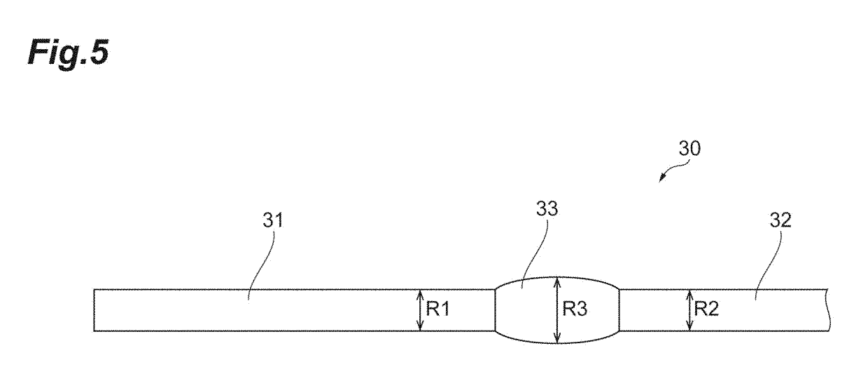

FIG. 3 is a perspective view illustrating the optical connector 20 having the optical connector ferrule 1. FIG. 4 is a sectional perspective view illustrating the optical connector 20. FIG. 5 is a side view illustrating one optical waveguiding member 30 that constitutes the optical connector 20. FIGS. 4 and 5 illustrate a state in which the optical connector 20 is in the middle of production. The optical connector 20 is finished by polishing tips of the optical waveguiding members 30 from this state along with the ferrule end face 2a, and arranging the tips of the optical waveguiding members 30 on the ferrule end face 2a.

As illustrated in FIG. 3, the optical connector 20 includes a plurality of optical tape fibers 21, for instance, four optical tape fibers 21 on the left, right, top and bottom, in addition to the optical connector ferrule 1. Each optical tape fiber 21 holds the plurality of optical waveguiding members 30, and the plurality of optical waveguiding members 30 are disposed in the optical tape fiber 21 on a straight line. For example, eight optical waveguiding members 30 are arranged in each optical tape fiber 21 in the direction A2.

As illustrated in FIG. 4, each optical tape fiber 21 includes a resin coating 22 that covers the optical waveguiding members 30. The resin coating 22 is removed from the middle of each optical tape fiber 21 to a tip thereof in the connecting direction A1, and thereby each optical waveguiding member 30 is exposed. These optical waveguiding members 30 are inserted into and held in the plurality of holding holes 4.

As illustrated in FIGS. 4 and 5, each optical waveguiding member 30 is formed in a linear shape. Each optical waveguiding member 30 includes a linear GRIN lens (a first optical waveguiding member) 31, a linear optical fiber (a second optical waveguiding member) 32, and a fusion part (a connecting part) 33 that connects the GRIN lens 31 and the optical fiber 32. The GRIN lens 31 and the optical fiber 32 are both formed in a round bar shape. In each optical waveguiding member 30, the GRIN lens 31 is located closer to a tip than the optical fiber 32.

The fusion part 33 connects one end of the GRIN lens 31 in a drawing direction and one end of the optical fiber 32 in the drawing direction. The fusion part 33 is formed in an elliptical shape in a side view, and is formed in a shape in which the middle portion thereof in the drawing direction is swollen. That is, the fusion part 33 has a largest diameter R3 at the middle portion thereof in the drawing direction. When a diameter of the GRIN lens 31 is defined as a diameter R1 and a diameter of the optical fiber 32 is defined as a diameter R2, the diameter R3 is larger than both the diameter RI and the diameter R2. In addition, an inner diameter of each holding hole 4 is larger than the diameter R3. The diameter R1 and the diameter R2 have, for instance, values that are almost equivalent to each other.

The optical waveguiding members 30 are inserted into the holding holes 4, and are thereby held in the optical connector ferrule 1.

The GRIN lenses 31 are led into the holding holes 4 formed in the front wall 7a of the first hole 7, and front ends of the GRIN lenses 31 protrude from the ferrule end face 2a. The fusion parts 33 are placed at the stepped parts 9 on the front wall 7a of the first hole 7. The optical fibers 32 extend backward from the fusion parts 33, and are covered with the resin coating 22 in the second hole 8.

Next, a method for producing the optical connector 20 configured as described above will be described. First, one end of the resin coating 22 of each optical tape fiber 21 is peeled off to expose the optical fibers 32 over a fixed region, and the GRIN lenses 31 are fused to the ends of the optical fibers 32, so that the optical waveguiding members 30 are formed. The optical waveguiding members 30 are inserted from the introduction hole 3 of the optical connector ferrule 1, and the GRIN lenses 31 are inserted into the holding holes 4 of the front wall 8a of the second hole 8.

The GRIN lenses 31 are inserted from the front wall 7a of the first hole 7 into the holding holes 4, and the GRIN lenses 31 are made to protrude from the ferrule end face 2a. In this case, the fusion parts 33 are loaded in the recesses 9a of the stepped parts 9, and positions of the fusion parts 33 in the connecting direction A1 are aligned with positions of the stepped parts 9. Since this alignment determines lengths of the GRIN lenses 31 in the connecting direction A1, there is a need to perform the alignment with high accuracy. In the present embodiment, lengths of the stepped parts 9 in the connecting direction A1 are substantially the same as lengths of the fusion parts 33 in the connecting direction A1, and thus the alignment of the fusion parts 33 with the stepped parts 9 is easily performed.

After the alignment of the fusion parts 33 in the connecting direction A1 is performed, an adhesive is introduced into and filled in the optical connector ferrule 1 from the second hole 8, and this adhesive is cured to thereby fix the optical waveguiding members 30. Portions of the GRIN lenses 31 which protrude from the ferrule end face 2a are cut to polish tips of the GRIN lenses 31 along with the ferrule end face 2a.

Due to this polishing, the tips of the GRIN lenses 31 are flush with the ferrule end face 2a, and the GRIN lenses 31 and the ferrule end face 2a are polished until the recesses 2g are gone. In this way, the polishing is performed until the recesses 2g are gone, and thereby the lengths of the GRIN lenses 31 are set to desired lengths, so that the optical connector 20 is finished.

As described above, the optical connector ferrule 1 includes the holding holes 4 into which the optical waveguiding members 30 in which the GRIN lenses 31 and the optical fibers 32 are connected via the fusion parts 33 are inserted, and the optical waveguiding members 30 are inserted into and held in the holding holes 4. The optical connector ferrule 1 includes the stepped parts 9 with which the fusion parts 33 of the optical waveguiding members 30 inserted into the holding holes 4 are aligned. Accordingly, the positions of the fusion parts 33 are matched with the stepped parts 9, and thereby the positions of the fusion parts 33 can be fixed with ease and with high accuracy. In this way, the positions of the fusion parts 33 can be fixed inside the optical connector ferrule 1, and thus the lengths of the GRIN lenses 31 inserted into the optical connector ferrule 1 can be adjusted with ease and with high accuracy.

The optical connector ferrule 1 includes the first hole 7 that allows the stepped parts 9 to be visible from the outside of the optical connector ferrule 1. Accordingly, since the stepped parts 9 are visible through the first hole 7, the alignment of the fusion parts 33 with the stepped parts 9 can be easily performed.

The optical connector ferrule 1 includes the recesses 2g that allows the polishing amount of the ferrule end face 2a to be visible from the outside of the optical connector ferrule 1. Since the polishing amount of the ferrule end face 2a is visible through the recesses 2g, the lengths of the GRIN lenses 31 extending from the stepped parts 9 to the ferrule end face 2a are also visible. Accordingly, the GRIN lenses 31 exposed to the ferrule end face 2a are polished, and thereby the lengths of the GRIN lenses 31 can be easily adjusted.

### Second Embodiment

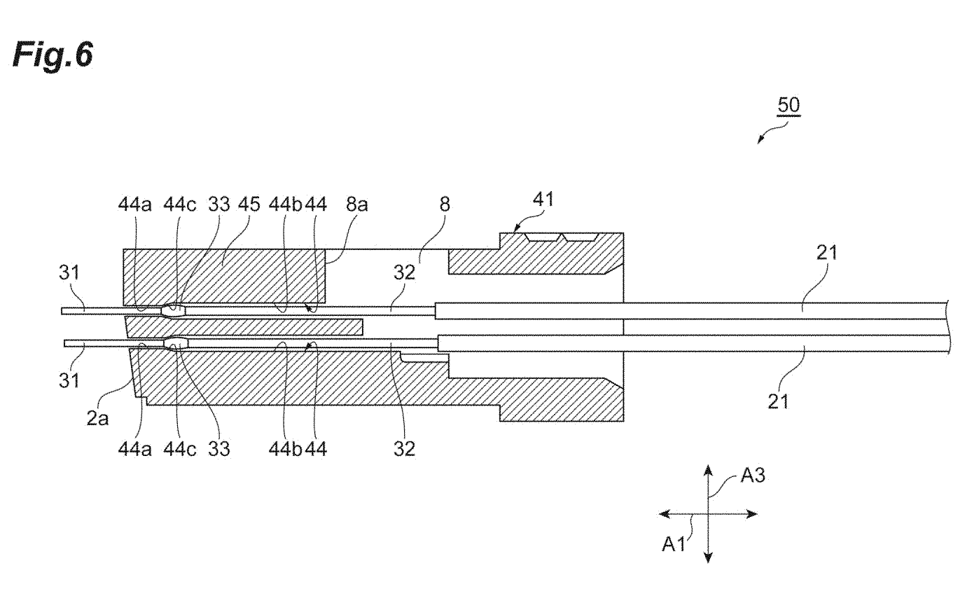

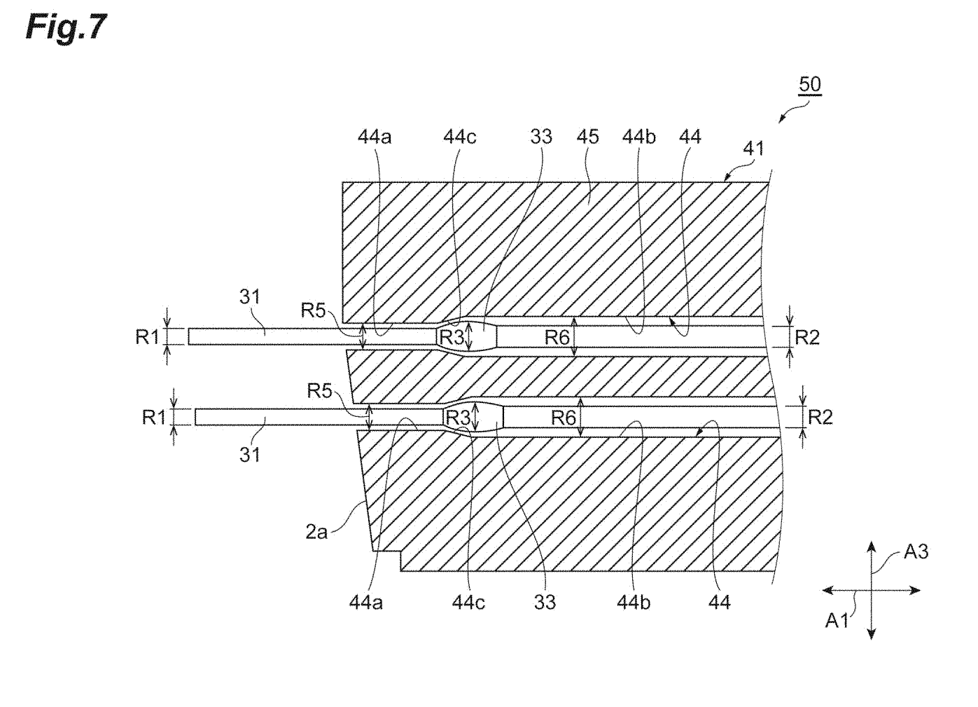

Next, an optical connector ferrule 41 according to a second embodiment and an optical connector 50 having the optical connector ferrule 41 will be described with reference to FIGS. 6 and 7. FIG. 6 is a side sectional view illustrating the optical connector 50, and FIG. 7 is an enlarged side sectional view of the vicinity of a ferrule end face 2a of the optical connector 50 of FIG. 6. Hereinafter, description overlapping the aforementioned details will be omitted.

The optical connector ferrule 41 according to the second embodiment is different from the optical connector ferrule 1 in that holding holes 44, each of which includes a small diameter part 44a and a large diameter part 44b, are formed instead of the holding holes 4 of the first embodiment, and a transparent part 45 that allows stepped parts 44c to be visible from the outside is provided instead of the first hole 7. In the second embodiment, the transparent part 45 is the entirety of the optical connector ferrule 41, and the entirety of the optical connector ferrule 41 is formed of a transparent material. However, the transparent part 45 may be provided only at a part of the optical connector ferrule 41.

Each holding hole 44 has the small diameter part 44a that extends from a ferrule end face 2a in a connecting direction A1, the large diameter part 44b that further extends from an end of the small diameter part 44a which is opposite to the ferrule end face 2a to the opposite side, and the stepped part 44c that is located between the small diameter part 44a and the large diameter part 44b. The small diameter part 44a and the large diameter part 44b extend together in the connecting direction A1, but each stepped part 44c is inclined with respect to the connecting direction A1. An inclined angle of each stepped part 44c with respect to the connecting direction A1 is, for instance, 30° or so, but it may be 90°, and may be appropriately changed.

The small diameter part 44a and the large diameter part 44b are both formed in a cylindrical hole shape. When a diameter of the small diameter part 44a is defined as a diameter R5, and a diameter of the large diameter part 44b is defined as a diameter R6, the diameter R5 is larger than a diameter R1 of each GRIN lens 31 and a diameter R2 of each optical fiber 32. However, the diameter R5 is smaller than a diameter R3 of each fusion part 33. On the other hand, the diameter R6 of the large diameter part 44b is larger than the diameter R3 of the fusion part 33.

With regard to a method for producing the optical connector 50 according to the second embodiment, as in the first embodiment, the GRIN lenses 31 are inserted into the holding holes 44 of a front wall 8a of a second hole 8, and the GRIN lenses 31 are made to protrude from the ferrule end face 2a. In this case, the fusion parts 33 abut the stepped parts 44c when the large diameter parts 44b are advanced. Thereby, alignment of the fusion parts 33 with the optical connector ferrule 41 is automatically performed. In this way, after the alignment of the fusion parts 33 is performed, as in the first embodiment, filling and curing of an adhesive, cutting of portions of the GRIN lenses 31 which protrude from the ferrule end face 2a, and polishing of the GRIN lenses 31 and the ferrule end face 2a are performed. Lengths of the GRIN lenses 31 are set to desired lengths, so that the optical connector 50 is finished.

As described above, in the optical connector ferrule 41, each holding hole 44 includes the small diameter part 44a that extends from the ferrule end face 2a and the large diameter part 44b that extends from an end opposite to the ferrule end face 2a, and the stepped part 44c provided between the small diameter part 44a and the large diameter part 44b functions as a mark part (a first mark part) for determining a position of the fusion part 33. Accordingly, the positions of the fusion parts 33 are matched with positions of the stepped parts 44c, and thereby the alignment of the fusion parts 33 can be performed with ease and with high accuracy.

The GRIN lens 31 is inserted into the small diameter part 44a, and is exposed at the ferrule end face 2a. The diameter R5 of the small diameter part 44a is smaller than the diameter R3 of the fusion part 33, and the diameter R6 of the large diameter part 44b is larger than the diameter R3 of the fusion part 33. Accordingly, the GRIN lens 31 is inserted into the small diameter part 44a, so that the fusion part 33 can be aligned with the stepped part 44c. In this state, the ferrule end face 2a and the GRIN lenses 31 are polished, and thereby the lengths of the GRIN lenses 31 can be adjusted.

Since the diameter R3 of the fusion part 33 is larger than the diameter R5 of the small diameter part 44a, and is smaller than the diameter R6 of the large diameter part 44b, when the GRIN lens 31 is inserted into the small diameter part 44a, the fusion part 33 automatically abuts the stepped part 44c. Accordingly, by inserting the GRIN lens 31 into the small diameter part 44a, the alignment of the fusion part 33 with the stepped part 44c can be more easily performed.

The optical connector ferrule 41 includes the transparent part 45 that allows the stepped parts 44c to be visible from the outside of the optical connector ferrule 41. Accordingly, since the stepped parts 44c are visible through the transparent part 45, the alignment of the fusion parts 33 with the stepped parts 44c can be easily performed. In the second embodiment, the transparent part 45 may also be omitted. Further, the transparent part 45 may also be formed in the optical connector ferrule 1 of the first embodiment.

### Third Embodiment

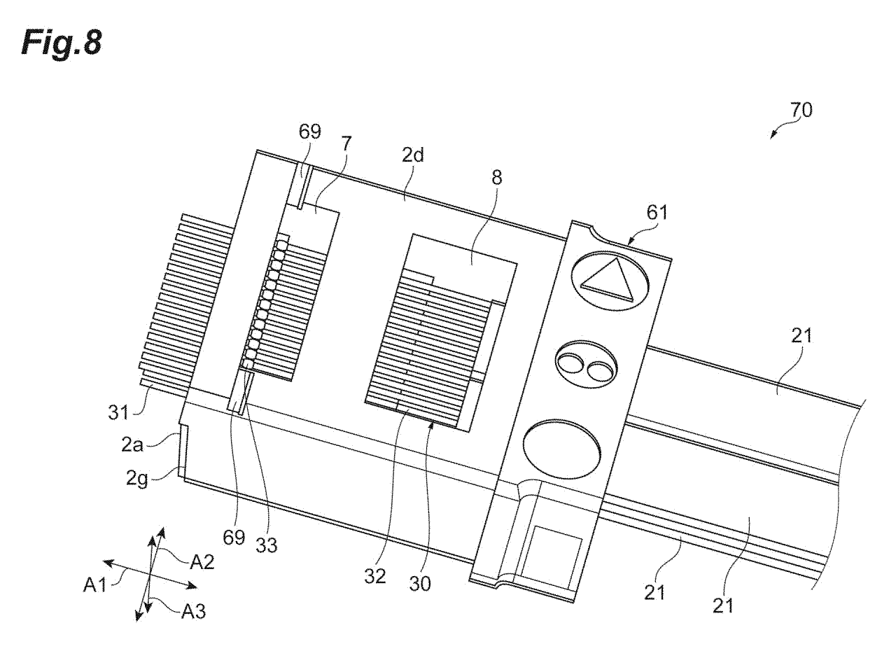

Subsequently, an optical connector ferrule 61 according to a third embodiment and an optical connector 70 having the optical connector ferrule 61 will be described with reference to FIG. 8. FIG. 8 is a perspective view illustrating the optical connector 70. The optical connector ferrule 61 according to the second embodiment is different from that of the first embodiment in that mark parts (first mark parts) 69 are provided instead of the stepped parts 9.

The mark parts 69 are provided to adjust positions of fusion parts 33 in a connecting direction A1, and are formed on an outer surface of the optical connector ferrule 61, that is, on a top surface 2d. The mark parts 69 are recesses that are recessed from the top surface 2d, and linearly extend in a direction A2. A width of each mark part 69 is substantially the same as, for instance, a length of each fusion part 33 in the connecting direction A1. The mark parts 69 are provided on opposite sides of a first hole 7 in the direction A2.

As described above, the optical connector ferrule 61 includes the mark parts 69 with which the fusion parts 33 of optical waveguiding members 30 inserted into holding holes 4 are aligned. Accordingly, by adjusting positions of the fusion parts 33 to the mark parts 69, the positions of the fusion parts 33 can be fixed with ease and with high accuracy. Therefore, the same effects as the first embodiment are obtained. A shape, number, and arrangement mode of the mark parts 69 can be appropriately changed without being limited to the above description.

The optical connector ferrule according to the present invention is not limited to the aforementioned embodiments, and can be variously modified as well. For example, in the aforementioned embodiments, the example in which the first optical waveguiding members are the GRIN lenses 31, the example in which the second optical waveguiding members are the optical fibers 32, and the example in which the connecting parts are the fusion parts 33 have been described. However, the configurations of the first optical waveguiding members, the second optical waveguiding member, and the connecting parts can be appropriately changed. For example, in place of the GRIN lenses 31, special optical fibers may be connected to the optical fibers 32 as the first optical waveguiding members, and various components may also be used as the second optical waveguiding members and the connecting parts.

In the aforementioned embodiments, the example in which the stepped parts 9 having the recesses 9a or the mark parts 69 are the first mark parts has been described. However, a shape, number, and arrangement mode of the first mark parts can be appropriately changed.

In the aforementioned embodiments, the example in which the second mark parts allowing the polishing amount of the ferrule end face 2a, that is, the length from the stepped parts 9 to the ferrule end face 2a, to be visible from the outside of the optical connector ferrule 1 is recesses 2g has been described. However, a shape, number, and arrangement mode of the second mark parts can be appropriately changed without being limited to the recesses 2g. In the aforementioned embodiments, the first hole 7 is exemplified as a hole through which the inside of the optical connector ferrule 1 is visible. However, a shape, number, and arrangement mode of this hole can also be appropriately changed.

A shape and size of each guide hole of the optical connector ferrule, and a shape, size, and number of the optical waveguiding members can also be appropriately changed. Further, in the aforementioned embodiments, the present invention is applied to a multi-fiber ferrule, but it may also be applied to a single-fiber ferrule.

### REFERENCE SIGNS LIST

1, 41, 61 Optical connector ferrule

2a Ferrule end face

2b Rear end face

2c Lateral surface

2d Top surface

2e Bottom surface

2f Front surface

2g Recess (second mark part)

3 Introduction hole

4, 44 Holding hole

6 Guide hole

7 First hole

7a Front wall

8 Second hole

8a Front wall

9 Stepped part (first mark part)

9a Recess

10 Stepped part

10a Recess

20, 50, 70 Optical connector

21 Optical tape fiber

22 Resin coating

30 Optical waveguiding member

31 GRIN lens (first optical waveguiding member)

32 Optical fiber (second optical waveguiding member)

33 Fusion part (connecting part)

44a Small diameter part

44b Large diameter part

44c Stepped part (first mark part)

45 Transparent part

69 Mark part (first mark part)

A1 Connecting direction

A2, A3 Direction

B Width

R1 to R3, R5, R6 Diameter

1. An optical connector ferrule comprising:
holding holes into which optical waveguiding members, each of which has a first optical waveguiding member, a second optical waveguiding member, and a connecting part that connects the first optical waveguiding member and the second optical waveguiding member, are inserted;
a ferrule end face at which the holding holes open and which faces a counterpart connector; and
first mark parts with which the connecting parts of the optical waveguiding members inserted into the holding holes are aligned.

2. The optical connector ferrule according to claim 1, wherein:
each of the holding holes includes a small diameter part that extends from the ferrule end face, and a large diameter part that extends from an end opposite to the ferrule end face; and
the first mark parts are stepped parts, each of which is provided between the small diameter part and the large diameter part.

3. The optical connector ferrule according to claim 2, wherein:
the first optical waveguiding member is a GRIN lens, the second optical waveguiding member is an optical fiber, and the connecting part is a fusion part that fuses the GRIN lens and the optical fiber;
the GRIN lens is inserted into the small diameter part, and is exposed at the ferrule end face;
a diameter of the fusion part is larger than a diameter of the GRIN lens;
a diameter of the small diameter part is smaller than the diameter of the fusion part, and is larger than the diameter of the GRIN lens; and
a diameter of the large diameter part is larger than the diameter of the fusion part.

4. The optical connector ferrule according to claim 2, further comprising a hole configured to allow the stepped parts to be visible from an outside of the optical connector ferrule.

5. The optical connector ferrule according to claim 2, further comprising a transparent part configured to allow the stepped parts to be visible from an outside of the optical connector ferrule.

6. The optical connector ferrule according to claim 1, further comprising second mark parts configured to allow a polishing amount of the ferrule end face to be visible from an outside of the optical connector ferrule.
